(19) United States
(12) Patent Application Publication
(10) Pub. No.: US 2015/0283523 A1
(43) Pub. Date: Oct. 8, 2015

(54) COMPRESSED AIR FOAM GENERATION

(71) Applicant: Waterous Company, South St. Paul, MN (US)

(72) Inventors: Ivan Arthur Clausen, Woodville, WI (US); Gregg Allen Geske, Chanhassen, MN (US); Jonathan David Gamble, Taylors Falls, MN (US)

(73) Assignee: Waterous Company, South St. Paul, MN (US)

(21) Appl. No.: 14/244,030

(22) Filed: Apr. 3, 2014

(51) Int. Cl. B01F 3/04; B01F 15/00; A62C 5/02; B01F 15/02

(52) U.S. Cl. CPC B01F 3/04446; B01F 3/04439; B01F 3/04992; B01F 15/026; B01F 15/00357; A62C 5/024; B01F 2215/008

(57) ABSTRACT

A foam generating system is disclosed that includes a liquid source providing liquid including at least one of water, an additive and a foaming agent. The system further includes a compressed gas source and a manifold coupled with the liquid source to receive liquid therefrom. A pressure control valve controls pressure of liquid flowing from the liquid source to the manifold and a plurality of foam generators fluidly coupled with the manifold. A control system is electrically coupled to the pressure control valve and each foam generator. In one implementation, the control system operates each of the foam generators to provide a first flow control state for a first type of foam output, a second flow control state for a second type of foam output and a water flow control state for liquid.

### BACKGROUND

Compressed air foam (CAF) is a useful tool in fire fighting and decontamination. CAF generation involves mixing an agent with water and ultimately introducing compressed gas into the resulting mixture. Current designs for generating foam provide limited maximum flow rates provided to one or more discharges of a fire truck. In instances where a high maximum flow is desired, a bypass line is used to direct flow around a connected flow generator. In addition to these deficiencies, further aspects of current foam generating systems include complex arrangements that have high production and maintenance costs.

### SUMMARY

A foam generating system is disclosed that includes a liquid source providing liquid including at least one of water, an additive and a foaming agent. The system further includes a compressed gas source and a manifold coupled with the liquid source to receive liquid therefrom. The manifold is fluidly coupled to a plurality of conduits spaced apart from and fluidly isolated from one another. A pressure control valve controls pressure of liquid flowing from the liquid source to the manifold and a plurality of foam generators fluidly coupled with the manifold. The plurality of foam generators can be transitioned between an active state and an inactive state and include a foaming chamber, a first valve assembly, a second valve assembly and an output. A control system is electrically coupled to the pressure control valve and each foam generator. The control system transitions each of the foam generators between the active state and the inactive state. The control system further operates each of the first valve assemblies and the second valve assemblies to provide a first flow control state for a first type of foam output, a second flow control state for a second type of foam output and a water flow control state for liquid.

### BRIEF DESCRIPTION OF THE DRAWINGS

FIG. 1 is a schematic block diagram of a foam generating system having a control system coupled with a foam generating assembly.

FIG. 2 is an isometric view of a foam generating assembly.

FIG. 3 is a sectional view of a foam generator of the foam generating assembly of FIG. 2.

FIG. 4 is an exploded view of a first valve assembly for the foam generator of FIG. 3.

FIG. 5 is an exploded view of a second valve assembly coupled with a foaming chamber for the foam generator of FIG. 3.

FIG. 6 is an exploded view of an output assembly for the foam generator of FIG. 3.

FIG. 7 is a flow diagram of a method for operating a foam generating assembly.

### DETAILED DESCRIPTION

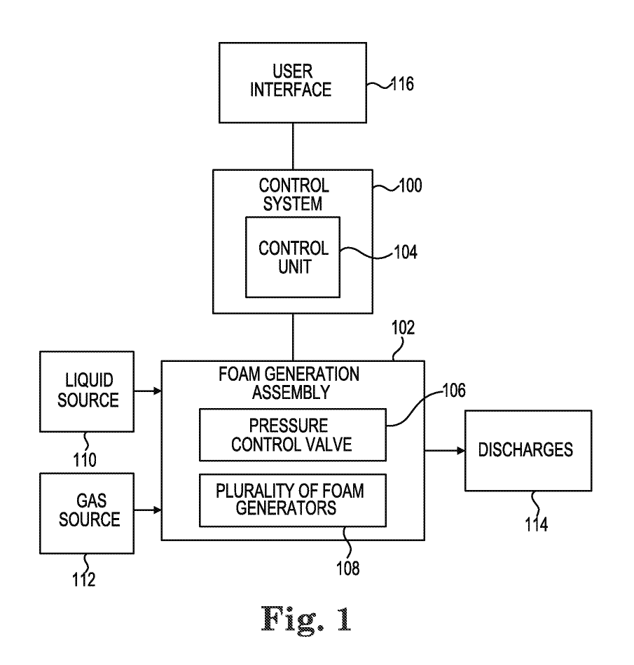

FIG. 1 is a schematic diagram of a foam generating system having a control system 100 operatively coupled with a foam generating assembly 102. The control system 100 includes a control unit 104 electrically coupled with a pressure control valve 106 and a plurality of foam generators 108 of foam generating assembly 102. In general, control system 100 operates to control the foam generating assembly 102 such that liquid from a liquid source 110 and gas from a gas source 112 provide a desired output to one or more discharges 114. As discussed in more detail below, control system 100 operates one or more liquid and gas valves of the foam generating assembly 102 to provide the desired output. In one embodiment, the system 100 is coupled with a user interface 116 that provides a user with the ability to operate control system 100. In one example implementation, the user can select a type of output generated by the plurality of foam generators 108 and a number of active foam generators from the user interface 116.

Control settings of the one or more valves can be based on a set of one or more calibrated settings that are established for a particular desired output. Alternatively, the one or more valves can be dynamically controlled with one or more established feedback loops. Example implementations for control system 100 are described in U.S. Patent Application Publication Nos. 2010/0126738 and 2013/0118763, the contents of which are hereby incorporated by reference in their entirety.

Liquid source 110, in one embodiment, provides a mixture of water with a foaming agent and an additive in a desired ratio so as to produce a particular type of foam. The type of foam can be dependent upon a type of fire presented for extinguishing. In one embodiment, the mixture is provided to foam generating assembly 102 in a manner as described in U.S. Patent Application Publication No. 2007/0209807, the contents of which are hereby incorporated by reference. In another embodiment, the liquid source 110 provides water only. Gas source 112 provides, in one embodiment, compressed gas (e.g., air) that is supplied to the liquid from liquid source 110 to create foam.

Control unit 104 is configured to operate the pressure control valve 106 so as to control pressure of liquid that is supplied from the liquid source 110 to the plurality of foam generators 108. A number of foam generators in the plurality of foam generators 108 can be two or more (e.g., two, three, four or more). Control unit 104 further operates each of the plurality of foam generators 108 to operate in either an active or inactive state. By controlling operation of the pressure control valve 106 and the plurality of foam generators 108, control system 100 can operate to efficiently and effectively generate foam as desired with respect to a type of fire to fight or a desired output to the one or more discharges 114. In particular, the control system 100 operates the foam generating assembly 102 to provide one or more flow control states. In one embodiment, these flow control states include a plurality of flow control states for different types of foam output. Each of these flow control states defines a setting for each of the valves in one or more active generators. In addition to these flow control states, a water flow control state is provided for liquid, which in one embodiment is comprised of only water. In the water flow control state, gas control valves for the flow generators 108 are closed to prevent gas from reaching corresponding foam generators such that only liquid is supplied to the one or more discharges 114.

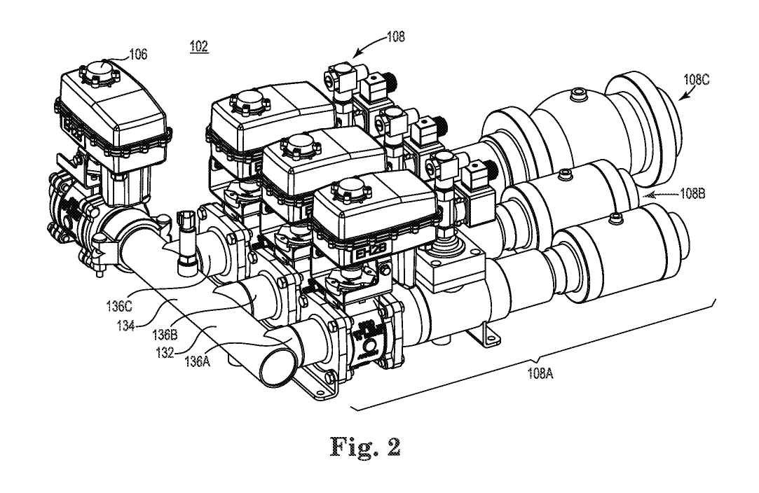

FIG. 2 is an isometric view of foam generating assembly 102 that is operatively controlled by the control system 100 of FIG. 1. Liquid (for example, a mixture of water, foaming agent and additive) is delivered through pressure control valve 106 to a manifold 132. In the embodiment illustrated, the manifold 132 includes a pressure sensor 134 that provides a feedback loop to control system 100 to determine proper operation of control valve 106. The manifold 132 is fluidly coupled with a plurality of conduits 136A-136C that carry liquid to the plurality of foam generators 108, herein illustrated as foam generators 108A-108C. Although three foam generators 108A-108C are illustrated, the foam generating assembly in other embodiments can have any number of foam generators, such as two, four, five or more. Each of the conduits 136A-136C are fluidly isolated from one another and spaced apart from one another. Providing spacing among the plurality of conduits 136A-136C allows maintenance for individual components of respective foam generators 108A-108C.

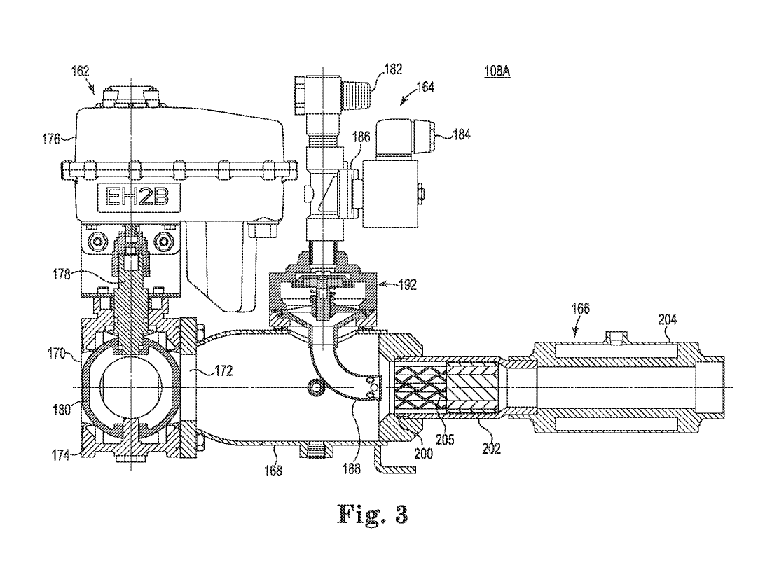

Each of the foam generators 108A-108C is similarly structured and details of foam generator 108A are described below with respect to FIGS. 3-5. In general, control system 100 operates each of the foam generators 108A-108C to establish a flow rate of liquid and a flow rate of gas to a foaming chamber in order to provide a desired output. Depending on a desired output and a number of active foam generators, the control system 100 operates pressure control valve 106 and the plurality of foam generators 108 to deliver a desired output to the plurality of discharges 114. In one example implementation, the control system 100 provides a first flow control state that generates a first type of foam output within a number of the plurality of foam generators 108 that are in an active state. Depending on the number of active foam generators, a pressure control setting is selected for the pressure control valve. For each active foam generator, a first setting is applied to the liquid valve so as to continuously supply liquid to the foaming chamber at a first constant volume flow rate. In addition, a second setting is applied to each gas valve so as to continuously supply gas to the foaming chamber at a second constant volume flow rate. In one embodiment, the first setting is altered as a function of the flow control state and the number of active foam generators, while the second setting is either an open or closed state.

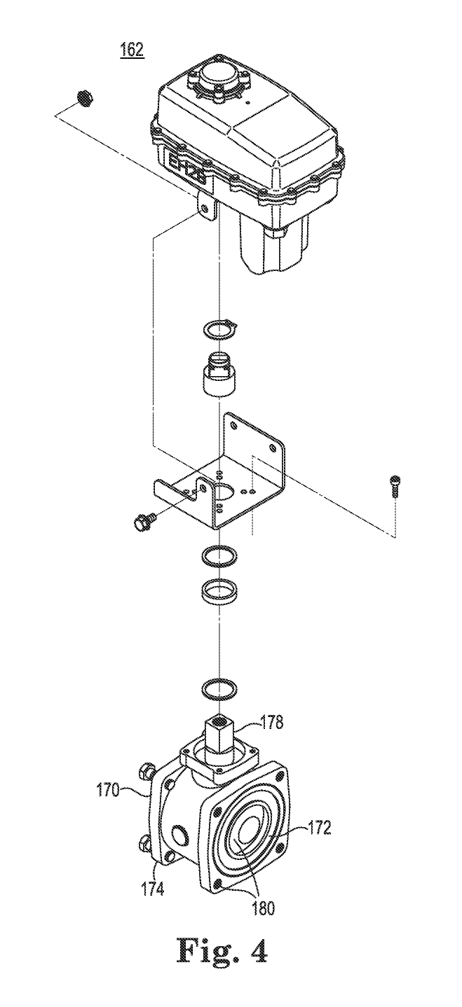

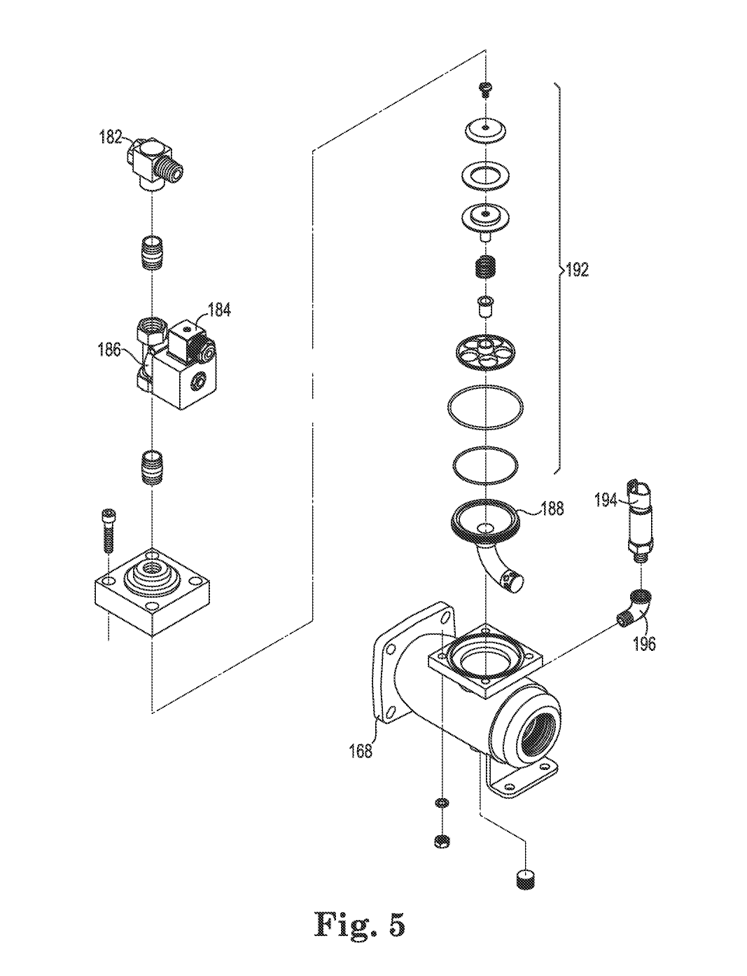

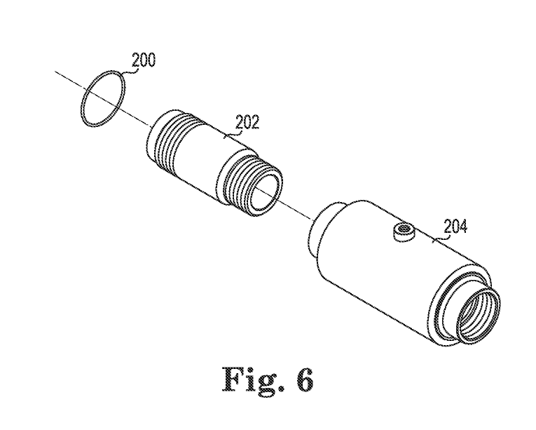

FIG. 3 is a schematic cross-sectional diagram of foam generator 108A. The foam generator 108A includes a first valve assembly 162 (exploded view in FIG. 4), a second valve assembly 164 (exploded view in FIG. 5) and an outlet assembly 166 (exploded view in FIG. 6). The first valve assembly 162 and the second valve assembly 164 are fluidly coupled with a foaming chamber 168. Valve assembly 162 controls a flow rate of liquid to foaming chamber 168 from an inlet port 170 to an outlet port 172 of a valve body 174. The valve assembly 162 includes a motorized actuator 176 that can be coupled with the control system 100 (FIG. 1) to control operation of the actuator 176. Actuator 176 is coupled with a valve stem 178 and a valve member 180 to control flow rate through the valve body 174. In the embodiment illustrated, valve member 180 is a ball, although other implementations of valve member 180 can be utilized. The flow rate through valve member 180 can be controlled to one or more predetermined calibrated settings or dynamically controlled as desired.

The second valve assembly 164 functions as a gas flow control assembly and includes a flow control valve 182, an electrical connector 184 and a solenoid valve 186. The flow control valve 182 is coupled with gas source 112 to receive compressed gas, for example compressed air from an air compressor. In one embodiment, the flow control valve 182 can be mechanically adjusted to a desired setting and control a flow rate to the solenoid valve 186. Electrical connector 184 is coupled to control system 100 and operates to change a setting for solenoid valve 186 based on signals provided to the electrical connector 184 from control system 100. Solenoid valve 186, in one embodiment, is an on/off valve that controls whether gas flowing through valve 182 is provided to a nozzle 188 disposed within the foaming chamber 168. When embodied as an on/off valve, solenoid valve 186 transitions between an open configuration and a closed configuration, depending on a flow control state for system 100. In the embodiment illustrated, a check valve assembly 192 is further provided to prevent gas from passing from nozzle 188 to valve 186. The flow rate though assembly 164 can be a predetermined setting (e.g., as determined by flow control valve 182 when solenoid valve 186 is an on/off valve), controlled to one or more predetermined calibrated settings or dynamically controlled as desired. As illustrated in FIG. 5, the gas valve assembly 164 can include a pressure sensor 194 coupled to the foaming chamber 168 through a connector 196. The pressure sensor 194 can provide feedback to the control system 100 as to a pressure level in the foaming chamber 168.

From foaming chamber 168, fluid is then provided to output assembly 166, which includes an O-ring 200, a connection pipe 202 and an output valve 204. Connection pipe 202 includes a mixing element 205 disposed therein. The mixing element 205 can be formed of various structures for mixing liquid from chamber 168 and from nozzle 188 to form compressed air foam that is sent to output valve 204. In one embodiment, the mixing element 205 is formed of a plurality of sieves as otherwise disclosed in U.S. Patent Application Publication No. 2010/0126738. In the embodiment illustrated, output valve 204 is an open loop pinch valve, although other valves can be implemented. A size and characteristic of the output valve 204 can be modified as desired. For example, as illustrated in FIG. 2, corresponding output valves for foam generators 108A and 108B are of similar size and shape, whereas the corresponding output valve for foam generator 108C is of a larger size and shape comparatively. The output valves can be selected based on a desired output from the foam generating assembly 102. For example, the foam generating assembly 102 may be configured to generate a combined output of 300 gallons per minute. In such a scenario, output valves for foam generators 108A and 108B could be equipped to generate output flows of 150 gallons per minute each. The output valve 108C can be selected to provide a greater output flow, as desired.

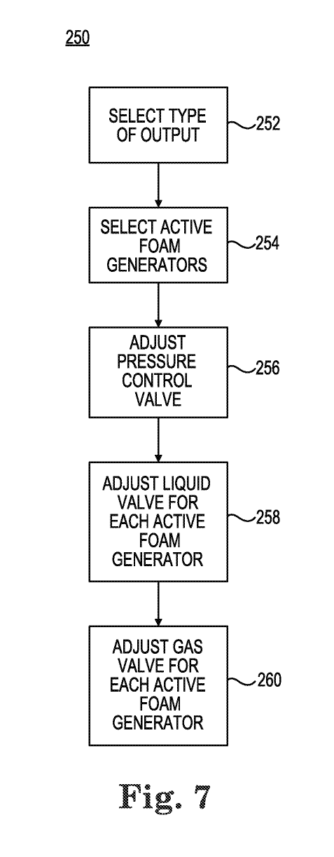

Given the above description of control system 100 and details of the foam generating assembly 102, FIG. 7 is a flow diagram of a method 250 for operation of the foam generating assembly 102 to establish one or more flow control states of the flow generating assembly 102. At step 252, a type of output is selected. For example, the user interface 116 can include a plurality of selections for different output types to be delivered to the discharges 114. These selections can include two or more different types of foam, a water only output without compressed gas and other selections as desired. Once the type of output is selected, a number of active foam generators are selected at step 254. The number of active foam generators can also be selected using the user interface 116. Given the type of output and number of active foam generators, the pressure control valve 106 is adjusted at step 256. For example, for a water only output, the pressure control valve may be positioned to a maximum setting, greater than a setting that would be provided for a foam output. At step 258, liquid valve assemblies for the active foam generators are adjusted depending on the type of output. Likewise, at step 260, gas valve assemblies for the active foam generators are adjusted depending on the type of output. For example, for a water only output, the gas valve assemblies of the active foam generators will be in a closed position.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof

What is claimed is:

1. A foam generating system, comprising:
a liquid source providing liquid including at least one of water, an additive, and a foaming agent;
a compressed gas source;
a manifold coupled with the liquid source to receive the liquid therefrom, the manifold fluidly coupled to a plurality of conduits spaced apart from and fluidly isolated from one another;
a pressure control valve controlling pressure of liquid flowing from the liquid source to the manifold;
a plurality of foam generators fluidly coupled with the manifold and configured to be transitioned between an active state and an inactive state, each foam generator including:
a foaming chamber,
a first valve assembly controlling liquid flow rate from one of the plurality of conduits to the foaming chamber,
a second valve assembly controlling gas flow rate from the compressed gas source to the foaming chamber, and
an output assembly fluidly coupled to the foaming chamber; and
a control system electrically coupled to the pressure control valve and each foam generator of the plurality of generators, the control system transitioning each of the foam generators between the active state and the inactive state to implement one or more active generators and operating the pressure control valve dependent upon a number of the one or more active generators, the control system further operating each of the first valves and the second valves for each of the one or more active generators to provide:
a first flow control state for a first type of foam output, the first flow control state defining a first setting for each of the first valve assemblies and the second valve assemblies in the one or more active foam generators;
a second flow control state for a second type of foam output, the second flow control state defining a second setting for each of the first valve assemblies and the second valve assemblies in the one or more active foam generators; and
a water flow control state for liquid, the water flow control state defining a third setting for each of the first valve assemblies in the one or more active foam generators with a greater level of flow than the first setting and the second setting, wherein each of the second valve assemblies prevent gas from reaching respective foaming chambers in the water flow control state.

2. The foam generating system of claim 1, wherein a number of foam generators in the plurality of foam generators is at least three.

3. The foam generating system of claim 1, wherein the pressure control valve is a motorized ball valve.

4. The foam generating system of claim 1, wherein each of the first valve assemblies includes a motorized ball valve.

5. The foam generating system of claim 1, wherein each of the second valve assemblies includes a solenoid valve.

6. The foam generating system of claim 1, further comprising a pressure sensor in the manifold coupled to the control system to provide an indication of pressure within the manifold.

7. The foam generating system of claim 1, wherein the output assembly includes a pinch valve.

8. The foam generating system of claim 1, further comprising a pressure sensor in the foaming chamber to provide an indication of pressure within the foaming chamber.

9. A foam generator for use in a foam generation assembly, comprising:
a foaming chamber;
a motorized ball valve controlling liquid flow rate from a liquid source to the foaming chamber;
a gas valve assembly controlling gas flow rate from a compressed gas source to the foaming chamber; and
an output assembly fluidly coupled to the foaming chamber, wherein the foam generator transitions among:
a first flow control state for a first type of foam output of the foam generator that defines a first setting for the motorized ball valve and wherein the gas valve assembly is in an open configuration;
a second flow control state for a second type of foam output of the foam generator that defines a second setting for the motorized ball valve that is different from the first setting, wherein the gas valve assembly is in the open configuration; and
a water flow control state for liquid that defines a third setting for the motorized ball valve with a greater level of flow than the first setting and the second setting, wherein the gas valve assembly is in a closed configuration to prevent gas from reaching the foaming chamber in the water flow control state.

10. The foam generator of claim 9, further comprising a pressure sensor in the foaming chamber to provide an indication of pressure within the foaming chamber.

11. The foam generator of claim 9, wherein the output assembly includes a pinch valve.

12. A method of operating a foam generating assembly, comprising:
selecting a type of output for the foam generation assembly, the type of output including one of a first type of foam output, a second type of foam output and a liquid only output;
selecting a number of active foam generators from a plurality of foam generators of the foam generating assembly;
adjusting a pressure control valve of the foam generating assembly based on the type of output and the number of active foam generators;
adjusting a liquid valve assembly for each liquid valve in the number of active foam generators based on the type of foam output; and
adjusting a gas valve assembly for each liquid valve in the number of active foam generators based on the type of foam output.

13. The method of claim 12, wherein the foam generating assembly includes a manifold fluidly coupled to a plurality of conduits spaced apart from and fluidly isolated from one another, each of the plurality of conduits fluidly coupled with one of the plurality of foam generators.

14. The method of claim 12, wherein for liquid only output, the pressure control valve and each of the liquid valve assemblies of the active foam generators define a flow rate setting that is greater than a corresponding setting for the first type of foam output and the second type of foam output.

15. The method of claim 12, wherein a number of foam generators in the plurality of foam generators is at least three.

16. The method of claim 12, wherein the pressure control valve is a motorized ball valve.

17. The method of claim 12, wherein each of the liquid valve assemblies includes a motorized ball valve.

18. The method of claim 12, wherein each of the gas valve assemblies includes a solenoid valve.
